(19) United States
(12) Patent Application Publication
(10) Pub. No.: US 2025/0035583 A1
(43) Pub. Date: Jan. 30, 2025

(54) APPARATUS TO ISOLATE VIBRATION FOR ELECTROPHORETIC MOBILITY MEASUREMENT

(71) Applicant: Wyatt Technology, LLC, Goleta, CA (US)

(72) Inventor: Siddharth Sood, Ventura, CA (US)

(21) Appl. No.: 18/783,749

(22) Filed: Jul. 25, 2024

Related U.S. Application Data
(60) Provisional application No. 63/529,411, filed on Jul. 28, 2023.

(51) Int. Cl. G01N 27/447

(52) U.S. Cl. CPC G01N 27/44708

(57) ABSTRACT

The present disclosure describes an apparatus to isolate vibration for electrophoretic mobility measurement. In an exemplary embodiment, the apparatus includes (1) at least four chassis pins coupled to a chassis of an electrophoretic mobility measurement instrument, (2) at least four fan pins coupled to a fan to cool the chassis, (3) at least four tension springs secured to the chassis via the chassis pins and to the fan via the fan pins, and (4) at least four compression springs positioned between a surface of the chassis and a surface of the fan, such that the tension springs are able to pull the fan against the compression springs.

### RELATED APPLICATION

This application claims priority to U.S. Provisional Patent Application No. 63/529,411 filed on Jul. 28, 2023 and titled “Apparatus to Isolate Vibration for Electrophoretic Mobility Measurement”, the entirety of which is incorporated by reference herein.

### BACKGROUND

The present disclosure relates to electrophoretic mobility, and more specifically, to an apparatus to isolate vibration for electrophoretic mobility measurement.

### SUMMARY

The present disclosure describes an apparatus to isolate vibration for electrophoretic mobility measurement. In an exemplary embodiment, the apparatus includes (1) at least four chassis pins coupled to a chassis of an electrophoretic mobility measurement instrument, (2) at least four fan pins coupled to a fan to cool the chassis, (3) at least four tension springs secured to the chassis via the chassis pins and to the fan via the fan pins, and (4) at least four compression springs positioned between a surface of the chassis and a surface of the fan, such that the tension springs are able to pull the fan against the compression springs.

### BRIEF DESCRIPTION OF THE DRAWINGS

FIG. 1A depicts an apparatus in accordance with an exemplary embodiment.

FIG. 1B depicts an apparatus in accordance with an exemplary embodiment.

FIG. 2A depicts an apparatus in accordance with an exemplary embodiment.

FIG. 2B depicts an apparatus in accordance with an exemplary embodiment.

FIG. 2C depicts an apparatus in accordance with an exemplary embodiment.

### DETAILED DESCRIPTION

The present disclosure describes an apparatus to isolate vibration for electrophoretic mobility measurement. In an exemplary embodiment, the apparatus includes (1) at least four chassis pins coupled to a chassis of an electrophoretic mobility measurement instrument, (2) at least four fan pins coupled to a fan to cool the chassis, (3) at least four tension springs secured to the chassis via the chassis pins and to the fan via the fan pins, and (4) at least four compression springs positioned between a surface of the chassis and a surface of the fan, such that the tension springs are able to pull the fan against the compression springs. In an embodiment, a chassis pin among the at least four chassis pins and a fan spring among the at least four fan pins secure a tension spring among the at least four tension springs. In an embodiment, the pins are selected from the group consisting of notched pins and glued pins. In an embodiment, the springs include helical springs. For example, the springs are helical springs.

In an embodiment, the apparatus mounts direct current fans on an off-the-shelf spring stack without welding or gluing to achieve vibration attenuation of approximately ten times on the primary fan frequency corresponding to the fan. In an embodiment, the fan is mounted to the chassis via a combination of tension springs and compression spring secured using pins on the tension spring on both ends such that the tension spring ‘pulls’ the fan against the compression spring. Also, in an embodiment, the tension springs and the compression springs are chosen such that (a) their total stiffness is as low as can be to have reasonable lateral stiffness, (b) the compression springs are compressed by the tension springs to a height above the solid height of the compression springs, and (c) the tension springs are tensioned by an amount more than that required to activate them (i.e., initial tension).

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns.

### Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometric response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photodetector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is a SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam (usually from a laser source producing a collimated beam of monochromatic light) that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photodetectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to Zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity, known as the mobility, that is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F(κa) to get from the mobility to a zeta potential).

Electrophoretic light scattering (ELS) involves applying an electric field to the sample in order to exert a force on the (charged) particles. In order to prevent the accumulation of charged particles onto the electrodes used to establish this electric field in an ELS measurement instrument, an alternating field is used, whose direction is switched (e.g., between positive and negative directions) rapidly enough to prevent charge build-up. During the application of a positive electric field, the sample acquires a positive velocity component, which leads to a positive Doppler frequency shift on the light that is scattered from the sample. During the application of a negative electric field, the sample acquires a velocity component in the opposite direction, which leads to a negative Doppler shift on the light that is scattered from the sample.

### Current Technology

Current ELS measurement instruments may experience undesirable vibrations from sources such as cooling fans used to cool such instruments. Some current ELS instruments attempt to isolate such vibrations from the chassis of the instrument by some means, such as with rubber anti-vibration mounts. Rubber anti-vibration mounts suffer from (i) there being a limited selection of direct current (DC) fans that could be used for such ELS instruments, and (ii) such DC fans not having critical performance information available (e.g., stiffness, damping) requiring an empirical determination of the correct mounts for a particular fan. However, such “correct” mounts typically only provide an attenuation of two to three times on the vibrational signature/primary fan frequency of the fan.

Other current ELS instruments attempt to be designed to have a low vibrational footprint. Such ELS instruments use “balanced” rotor fans that offer reduced vibrational signatures. However, using such “balanced” rotor fans suffer from (i) a limited number of vendors that sell balanced rotor fans and (ii) the vibrational signatures of such fans still not being low enough for ELS instruments, especially since the fan balancing feature primarily serves to increase the lifespan of the fan (not to minimize the vibration output of the fan).

In general, instruments also may attempt to isolate vibration via metal springs with low stiffness. As it is possible to get lower stiffness using metal compression springs than with rubber mounts, a greater degree of isolation could be achieved by using low stiffness metal springs. However, since the fans need to have low mass, the springs need to have very low stiffness to achieve the right natural frequency, thereby making such springs fragile to handle and not amenable to welding or gluing, as required for ELS instruments. Moreover, sideways mounting of fans is also challenging as lateral stiffness, proportional to axial stiffness, would also be very low. Thus, there is a need for an apparatus to isolate vibration for electrophoretic mobility measurement.

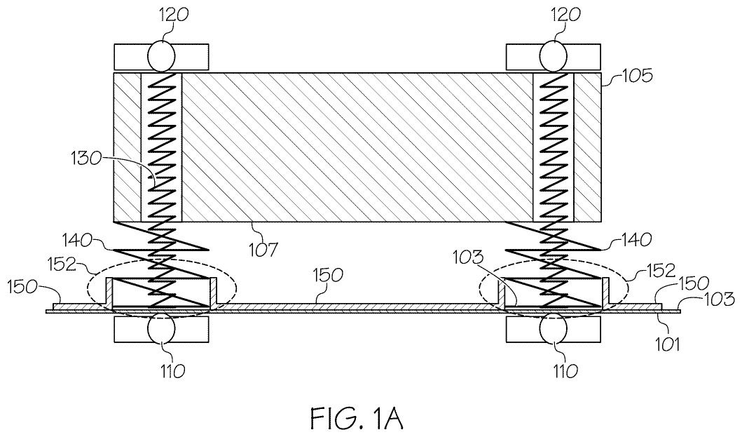

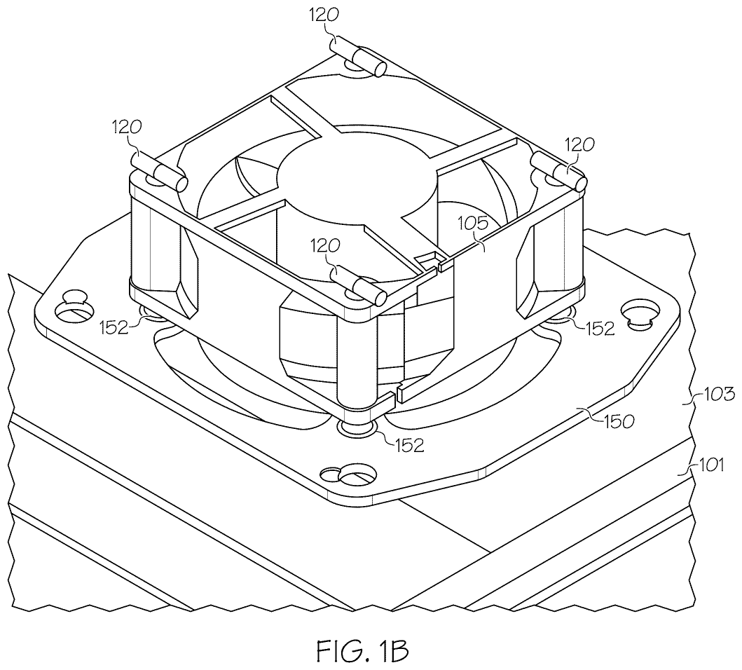

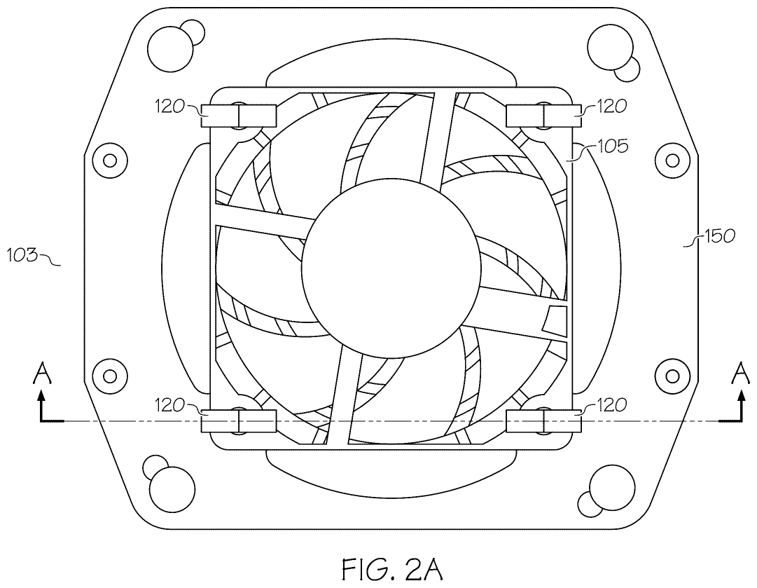

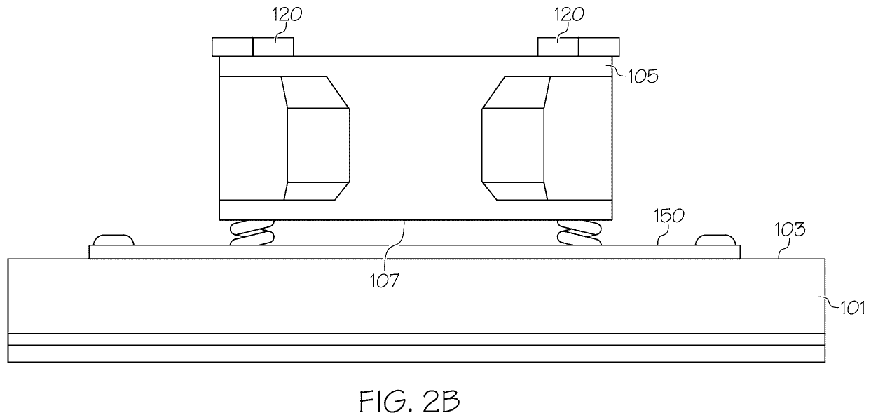

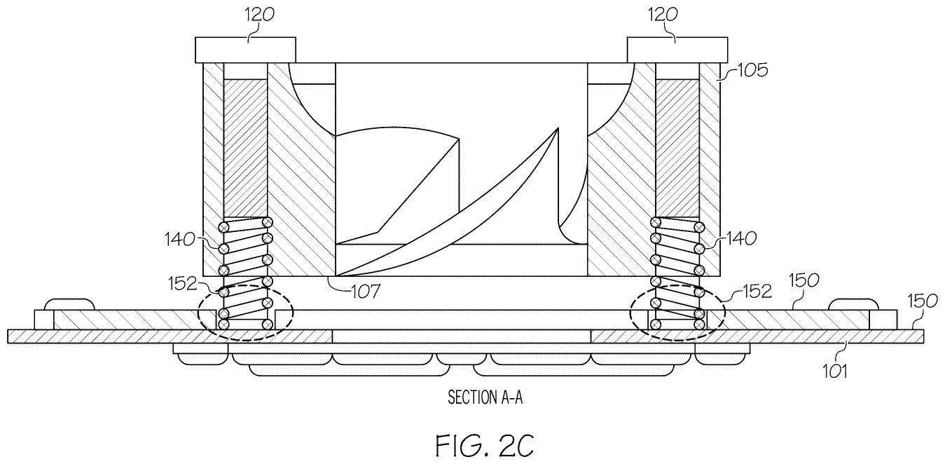

Referring to FIG. 1A, FIG. 1B, FIG. 2A, FIG. 2B, and FIG. 2C, in an exemplary embodiment, in exemplary embodiment, the apparatus includes (1) at least four chassis pins 110 coupled to a chassis 101 of an electrophoretic mobility measurement instrument, (2) at least four fan pins 120 coupled to a fan 105 to cool chassis 101, (3) at least four tension springs 130 secured to chassis 101 via chassis pins 110 and to fan 105 via fan pins 120, and (4) at least four compression springs 140 positioned between a surface 103 of chassis 101 and a surface 107 of fan 105, such that tension springs 130 are able to pull fan 105 against compression springs 140.

### Alignment

In a further embodiment, as depicted in FIG. 1A, FIG. 1B, FIG. 2A, FIG. 2B, and FIG. 2C, the apparatus further includes an alignment baffle 150 connected to surface 103 of chassis 101, where baffle 150 includes at least four pockets 152 to ensure that tension springs 130 and compression springs 140 do not become entangled with each other. In an embodiment, alignment baffle 150 could ensure proper alignment between tension springs 130 and compression springs 140.

In an embodiment, chassis 101 includes at least four pockets to ensure that tension springs 130 and compression springs 140 do not become entangled with each other. In an embodiment, the at least four pockets could ensure proper alignment between tension springs 130 and compression springs 140. For example, the pockets could be milled or stamped in chassis 101, obviating the need for baffle 150. Also, in an embodiment, spring retention features are stamped directly in chassis 101, thereby eliminating the need for pins to retain tension springs 130 on chassis 101.

### Example

For example, the apparatus has been observed to achieve an attenuation of vibrations of approximately ten times on primary vibrational/fan frequency corresponding to the fan by using springs 130, 140 with a low natural frequency relative to the primary vibrational/fan frequency. Also, it has been observed that the combination of tension springs 130 and compression springs 140 offers higher lateral stiffness than just an equivalent compression spring.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. An apparatus comprising:
at least four chassis pins coupled to a chassis of an electrophoretic mobility measurement instrument;
at least four fan pins coupled to a fan to cool the chassis;
at least four tension springs secured to the chassis via the chassis pins and to the fan via the fan pins; and
at least four compression springs positioned between a surface of the chassis and a surface of the fan, such that the tension springs are to pull the fan against the compression springs.

2. The apparatus of claim 1 further comprising an alignment baffle connected to the surface of the chassis,
wherein the baffle comprises at least four pockets to ensure that the tension springs and the compression springs do not become entangled with each other.

3. The apparatus of claim 1 wherein the chassis comprises at least four pockets to ensure that the tension springs and the compression springs do not become entangled with each other.

4. The apparatus of claim 1 wherein the pins are selected from the group consisting of notched pins and glued pins.

5. The apparatus of claim 1 wherein the springs comprise helical springs.
